(19) United States
(12) Patent Application Publication
(10) Pub. No.: US 2024/0071362 A1
(43) Pub. Date: Feb. 29, 2024

(54) NOISE CANCELLATIONS VIA SYSTEM MANAGEMENT BUSES

(71) Applicant: HEWLETT-PACKARD DEVELOPMENT COMPANY, L.P., Spring, TX (US)

(72) Inventors: Chao-Wen Cheng, Taipei City (TW); Tsung Yen Chen, Taipei City (TW); Wen Shih Chen, Taipei City (TW); Mo-Hsuan Lin, Taipei City (TW); Juiching Chang, Taipei City (TW)

(21) Appl. No.: 17/894,337

(22) Filed: Aug. 24, 2022

(51) Int. Cl. G10K 11/178

(52) U.S. Cl. CPC G10K 11/17885; G10K 11/17823; G10K 11/17854

(57) ABSTRACT

In example implementations, a computing device is provided. The computing device includes a system management bus, a controller communicatively coupled to the system management bus, a noise generating component communicatively coupled to the controller, a noise cancellation codec communicatively coupled to the system management bus, and a speaker communicatively coupled to the noise cancellation codec. The operating parameters of the noise generating component are provided to the controller. The noise cancellation codec is to receive the operating parameters of the noise generating component from the controller via the system management bus and to generate a noise cancellation signal based on the operating parameters. The speaker outputs the noise cancellation signal to cancel noise generated by the noise generating component.

### BACKGROUND

Computing devices can be used to execute various applications and programs. A processor is deployed in a computing device to execute the applications and programs. The computing device can have additional components that can help execute the applications, such as memory, graphics processors, and the like.

The computing device may generate loud noises during operation. For example, the computing device may have a fan that can turn on during operation. The various components within the computing device can generate heat. The internal fan of the computing device can be activated to try to lower the internal temperature of the computing device.

### BRIEF DESCRIPTION OF THE DRAWINGS

FIG. 1 is a block diagram of a computing device with an example active noise cancellation performed via an active noise cancellation codec without a microphone;

FIG. 2 is a block diagram of a computing device with an example active noise cancellation performed via a system management bus and an active noise cancellation codec;

FIG. 3 is another block diagram of a computing device with an example active noise cancellation performed via a system management bus and an active noise cancellation codec;

FIG. 4 is a flow chart of an example method to generate a noise cancellation signal of the present disclosure; and

FIG. 5 is an example non-transitory computer readable storage medium storing instructions executed by a processor to generate a noise cancellation signal of the present disclosure.

### DETAILED DESCRIPTION

Examples described herein provide a computing device and method to perform active noise cancellation via a system management bus. As discussed above, computing devices may generate loud noises during operation. For example, the computing device may have a fan that can turn on during operation. The various components within the computing device can generate heat. The internal fan of the computing device can be activated to try to lower the internal temperature of the computing device.

Previous active noise cancellation systems may use a microphone to provide an input to the active noise cancellation codec. For example, the microphone may be placed near components that may generate noise to capture sound signals from the components. The sound signals may then be provided to the active noise cancellation codec for analysis such that the active noise cancellation codec can generate a counter sound signal to negate the sound signals generated by the components of the computing device.

However, the microphone may also capture background noise or environmental noise. Due to the additional background noise captured by the microphone, the counter sound signal generated by the active noise cancellation codec may not be accurate. As a result, the counter sound signal generated by the active noise cancellation codec may not perfectly cancel the sound generated by the components of the computing device.

In addition, the microphone may increase the cost of the computing device by deploying additional hardware. Wiring of the microphone to the active noise cancellation codec may also increase manufacturing costs and complexity to configure the computing device.

The present disclosure provides active noise cancellation using a system management bus (SMBus) to collect information that can be used to generate a noise cancellation signal. The active noise cancellation of the present disclosure avoids reliance on sound captured by a microphone. Thus, the active noise cancellation system of the present disclosure may generate a more accurate noise cancellation signal to improve noise cancellation of sound generated by components of the computing device. In addition, eliminating the use of a microphone may also reduce costs and complexity associated with manufacturing the computing device.

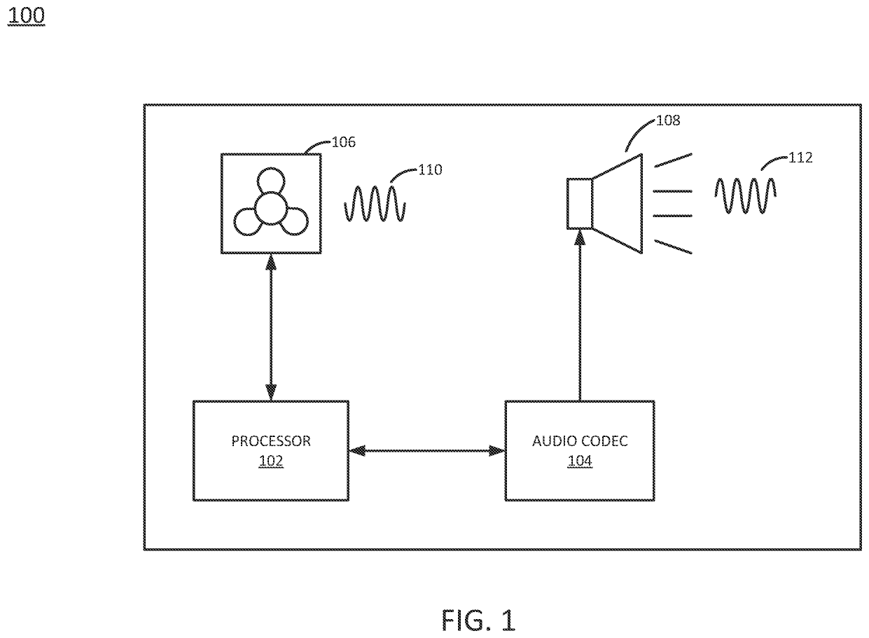

FIG. 1 illustrates an example computing device 100 that can provide active noise cancellation without using a microphone. In an example, the computing device 100 may include a processor 102, an audio codec 104 (also referred to herein as a noise cancellation codec or simply a codec), a speaker 108, and a noise generating component 106. The processor 102 may be communicatively coupled to the audio codec 104 and the noise generating component 106. The processor 102 may control operation of the audio codec 104 and the noise generating component 106.

In an example, the noise generating component 106 may be any device that can generate noise within the computing device 100. For example, the noise generating component 106 may be fan, a graphics processor with a dedicated fan, a mechanical hard disk drive, or any other noise generating component or device.

During operation of the computing device 100, the noise generating component 106 may generate a sound signal 110. The sound signal 110 may vary in loudness or decibel level during operation. At some decibel levels, the noise may be undesirable.

For example, the noise generating component 106 may be a fan. As the computing device 100 continues to operate, the components within the computing device 100 may generate more heat. As the temperature rises within the computing device 100, the noise generating component 106 (e.g., a fan) may turn on. The blades of the fan may begin to rotate to generate air circulation that can cool the inside of the computing device 100. As more heat is generated by the computing device 100, the fan may rotate faster at higher rotations per minute (RPMs) to try and generate more air flow and increase cooling within the computing device 100. The faster the fan rotates, the more noise the fan may generate, which can lead to an undesirable amount of noise.

The RPMs of the fan can be correlated to a noise level. By correlating the RPMs of the fan to a noise level or decibel level, the microphone can be removed from the system to generate a noise cancelling signal, as discussed in further detail below. However, other parameters can be correlated to a noise level for the noise generating component (e.g., mechanical spin rate of a mechanical hard disk drive).

The audio codec 104 may generate a noise cancelling signal 112 that can be combined with the sound signal 110 to cancel the noise generated by the noise generating component 106. Said another way, the audio codec 104 may generate a noise cancelling signal 112 that can reduce the decibel level perceived by a user of the sound signal 110 generated by the noise generating component 106. For example, the noise cancelling signal 112 may have a waveform that has a pattern that is the inverse of the waveform of the sound signal 110.

The noise cancelling signal 112 may be output by the speaker 108. The speaker 108 may be located near the noise generating component 106. For example, if noise from a particular noise generating component 106 is to be canceled, the speaker 108 may be located near the particular noise generating component 106.

Previous noise cancelling audio codecs relied on a microphone. As discussed above, the microphone would collect sound signals and provide the sound signals to the audio codec to be analyzed such that an inverse noise cancelling signal could be generated. However, the microphone could capture ambient sounds or environmental sounds. The additional sounds could negatively affect the generation of the noise cancelling signal. As a result, the noise cancelling signal may not be as effective at reducing the perceived sound level of the sound generated by a noise generating component.

The present disclosure, by contrast, does not use a microphone to generate the noise cancelling signal 112. Rather, the processor 102 may obtain various operating parameters of the noise generating component 106. The operating parameters may be correlated to a particular noise level or decibel level of the sound signal 110 by the audio codec 104. The audio codec 104 may then generate the noise cancellation signal based on the decibel level correlated from the operating parameter or parameters of the noise generating component 106.

In an example, the operating parameter of the noise generating component 106 may include a current fan speed, a current power consumption, a current temperature within the computing device 100, and the like. In some examples, product information associated with the noise generating component 106 may also be used to determine the decibel level of the sound signal 110. The product information may include a model number or a serial number. For example, different model number devices may generate different sounds signals 110 at a particular fan speed or a particular power consumption level. Thus, the operating parameter and the product information can be used to determine a decibel level of the sound signal 110.

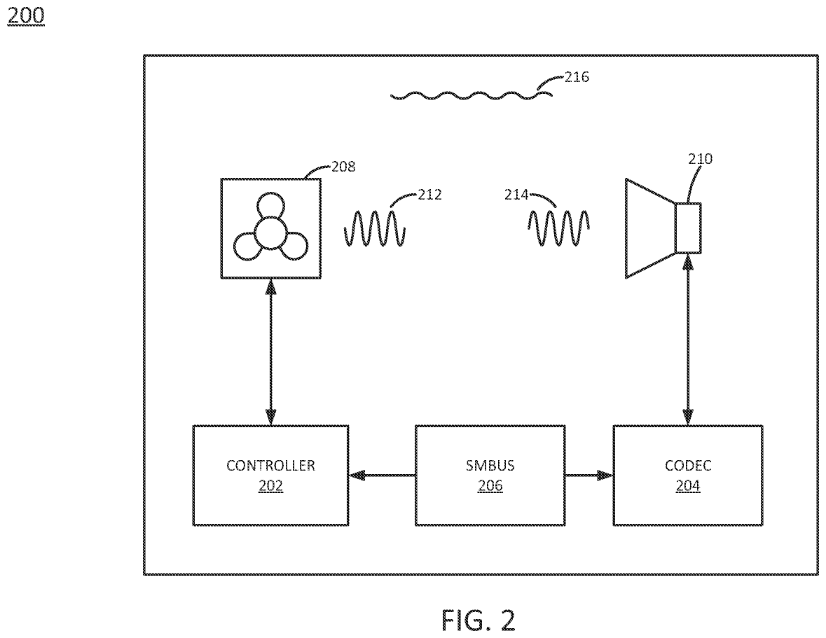

FIG. 2 illustrates a block diagram of a computing device 200 with an example active noise cancellation performed via a system management bus (SMBus) 206. The SMBus 206 may also be an inter-integrated circuit (I² C) bus. As noted above, the noise cancellation can be performed without a microphone. An example implementation may include collecting operating parameters of a noise generating component 208 over the SMBus 206.

In one example, the computing device 200 may include a controller 202, a codec 204 (also referred to herein as a noise cancellation codec or simply a codec), the SMBus 206, the noise generating component 208, and a speaker 210. The noise generating component 208 may be a fan, a graphics processor with a dedicated fan, a mechanical hard disk drive, or any other component within the computing device 200 that can generate noise.

The controller 202 may be communicatively coupled to the noise generating component 208. The controller 202 may be communicatively coupled to the codec 204 via the SMBus 206. The controller 202 may collect an operating parameter or operating parameters of the noise generating component 208 and transmit the operating parameter(s) to the codec 204 via the SMBus 206. In one example, the controller 202 may be a super input/output controller or an embedded controller.

The codec 204 may be an audio codec 204 that may generate a noise cancelling signal 214. The codec 204 may analyze the operating parameter to generate the noise cancelling signal 214. In an example, the codec 204 may use a table that includes product information that correlates operating parameters to a decibel level of a sound signal 212 that is generated by the noise generating component 208. The codec 204 may generate the noise cancelling signal 214 to have an inverse waveform of the sound signal 214.

As illustrated in FIG. 2, the codec 204 may provide the noise cancelling signal 214 to the speaker 210 to be outputted by the speaker 210. The speaker 210 may be located near the noise generating component 208. The noise cancelling signal 214 may be combined with the sound signal 212 to generate a reduced sound signal 216. The amplitude of the wave form of the reduced sound signal 216 is lower than the sound signal 212 due to combination with the noise cancelling signal 214.

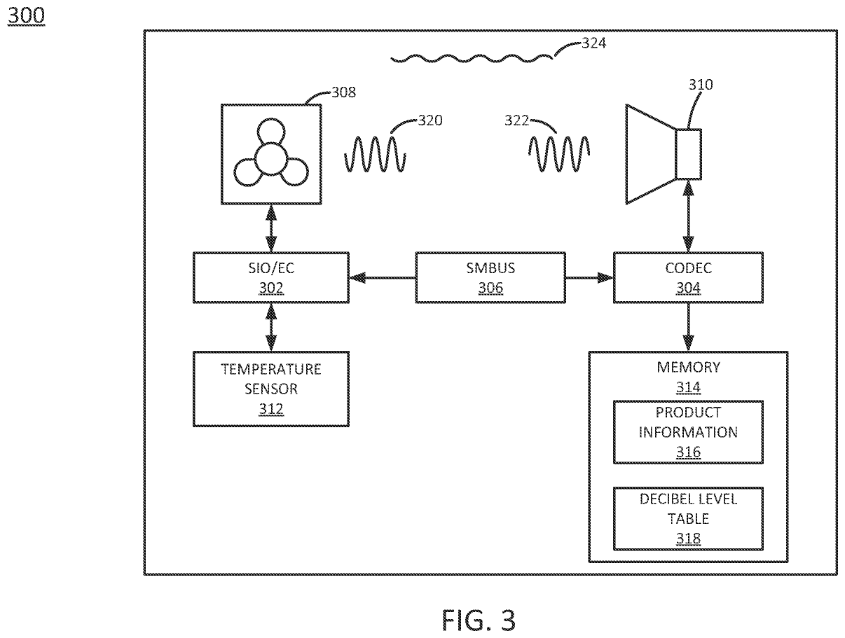

FIG. 3 illustrates another block diagram of a computing device 300 with an example noise cancellation performed via an SMBus 306 and an active noise cancellation codec 304 (also referred to herein as an audio codec or simply a codec). The computing device 300 may include system input/output embedded controller (SIO/EC) 302 that controls communications over the SMBus 306. The SIO/EC 302 may be communicatively coupled to a noise generating component 308 to receive various information from the noise generating component 308.

In an example, the noise generating component 308 may be a fan. For example, the fan may be a cooling fan for the computing device 300 or a fan on a discrete graphics card installed in the computing device 300. The SIO/EC 302 may receive operating parameters from the fan. For example, the operating parameters may include a fan speed (e.g., rotations per minute (RPM)), a performance mode (e.g., always on, a set RPM level by a user, gaming mode associated with a particular RPM speed, and the like) a power consumption of the fan (e.g., voltage supplied to the fan or current supplied to the fan) and the like.

The operating parameters may be provided to the codec 304 by the SIO/EC 302 over the SMBus 306. The codec 304 may be communicatively coupled to a memory 314. The memory 314 may be a non-transitory computer readable medium. For example, the memory 314 may be local memory of the codec 304, a random access memory (RAM), a read-only memory (ROM), a solid stated drive, a non-volatile memory express (NVMe) memory, and the like.

The memory 314 may store product information 316 and a decibel level table 318. The product information 316 may include information associated with the noise generating component 308 within the computing device 300. The product information 316 may help the codec 304 identify what type of noise generating component or components 308 are installed in the computing device 300 and which noise generating component 308 the operating parameters are being obtained from by the SIO/EC 302. The product information 316 may include a model number, a serial number, a product name, and the like.

The decibel level table 318 may include predefined tables for the noise generating components 308 or for each noise generating component 308 if multiple noise generating components 308 are installed in the computing device 300. For example, the table 318 may correlate an operating parameter or multiple operating parameters to an observed decibel level of a sound signal 320 generated by the noise generating component 308.

For example, for a particular model fan, the table 318 may provide a linear correlation between RPM and decibel level. In another example, the table 318 may provide a linear correlation between power consumption and decibel level. In another example, the table 318 may provide a correlation between an internal temperature, predicted fan RPM, and power consumption to decibel level.

Thus, the codec 304 may determine the predicted decibel level of the sound signal 320 using the product information 316 and the table 318. The codec 304 may generate a noise cancelling signal 322 to cancel the decibel level of the sound signal 320. The noise cancelling signal 322 may be provided to a speaker 310 to be outputted by the speaker 310. The speaker 310 may be located near the noise generating component 308.

The noise cancelling signal 322 may be combined with the sound signal 320 to generate a modified sound signal 324. The modified sound signal 324 may be have a lower decibel level than the sound signal 320. For example, the amplitude of the wave form of the modified sound signal 324 may be much lower than the amplitude of the wave form of the sound signal 320.

In an example, the computing device 300 may include additional sensors to activate the codec 304 or the noise cancellation. For example, a decibel level of the sound signal 320 below a threshold may be acceptable. Thus, a sensor may be used to activate the codec 304 and begin noise cancellation.

In an example, the sensor may be a temperature sensor 312. For example, the internal temperature of the computing device 300 may be correlated to a predicted RPM or power consumption of the noise generating component 308. The predicted RPM or power consumption may be correlated to a decibel level. Thus, a particular temperature threshold may be set to a temperature at which the noise generating component 308 may operate at a decibel level that is unacceptable. The temperature threshold may be stored in a memory (not shown) communicatively coupled to the SIO/EC 302 or in the memory 316.

When, the temperature threshold is exceeded, the SIO/EC 302 may activate the codec 304 over the SMBus 306. The SIO/EC 302 may obtain operating parameters of the noise generating component 308 and transmit the operating parameters to the codec 304 over the SMBus 306. The codec 304 may then generate the noise cancelling signal 322, as described above.

At a later time, when the internal temperature of the computing device 300 falls below the temperature threshold, the SIO/EC 302 may deactivate the codec 304. Selectively turning the codec 304 on and off may reduce overall power consumption and save energy consumption and/or battery life of the computing device 300.

In an example, the temperature threshold may be set by a user via a graphical user interface (not shown) of the computing device 300. For example, different users may have different acceptable levels of noise generated by the noise generating component 308. For example, some users may not care how loud the sound signal 320 is and want to maximize battery life. As a result, the user may set the temperature threshold to a maximum allowable temperature.

In another example, a user may be in a quiet environment and want to make sure the decibel level of the sound signal 320 does not disturb other users. As a result, the user may set the temperature threshold to a minimum level or set the codec 304 to always on such that the decibel level of the sound signal 320 is cancelled as much as possible.

Thus, the preset disclosure provides various examples of computing devices 100, 200, and 300 that can perform noise cancellation without a microphone. Since the noise cancellation is performed based on the actual noise generated by the noise generating components (e.g., a fan) rather than a sound recording that can include additional environmental noise, the noise cancellation may be more accurate.

In addition, the audio codec that generates the noise cancellation signal may be automatically controlled based on a temperature threshold. Thus, a user does not need to manually turn the noise cancellation on and off. In addition, the audio codec can be selectively turned on and off based on personally acceptable noise levels to save power consumption (and battery life if the device is battery operated) of the devices 100, 200, and 300.

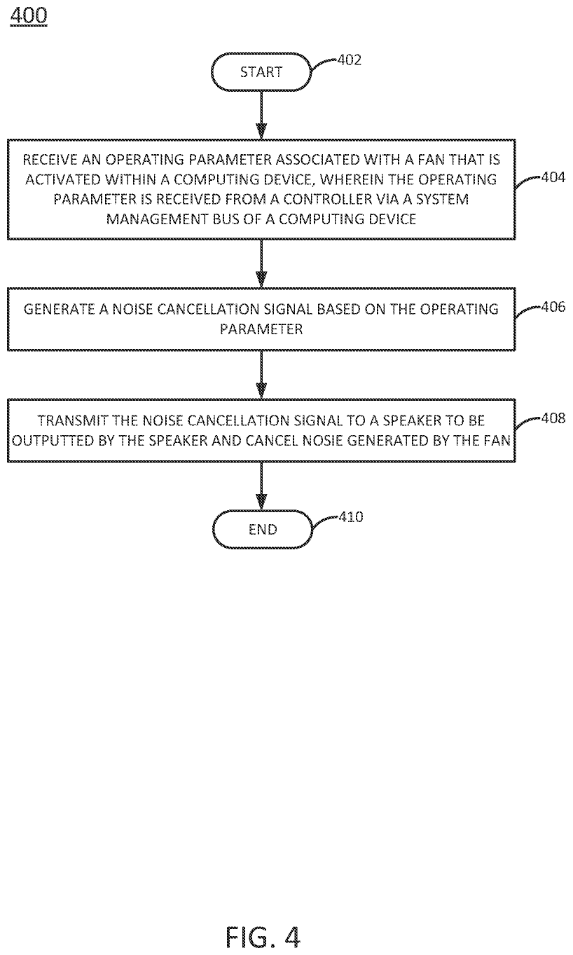

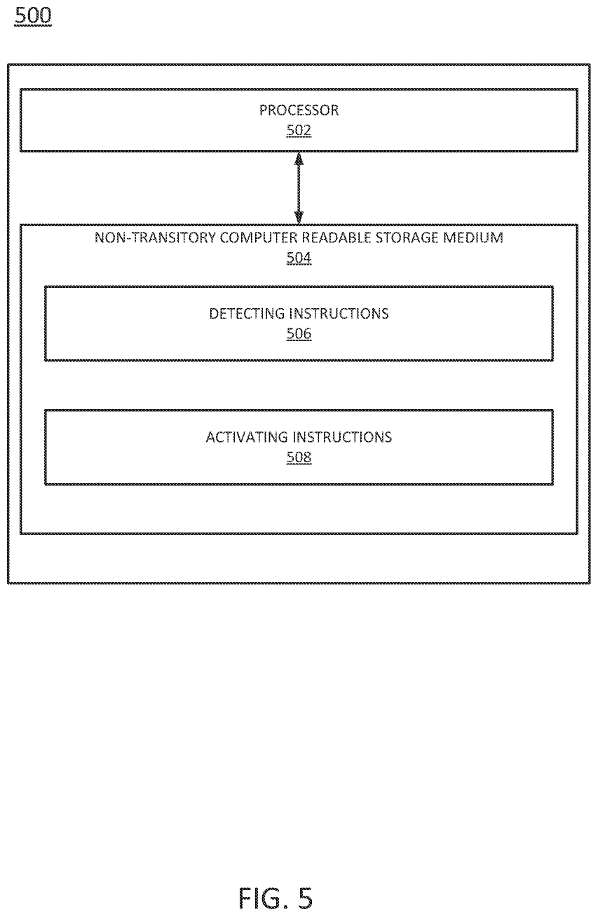

FIG. 4 illustrates a flow diagram of an example method 400 to generate a noise cancellation signal of the present disclosure. In an example, the method 400 may be performed by an audio codec of the computing device 100 illustrated in FIG. 1, an audio codec of the computing device 200 illustrated in FIG. 2, an audio codec of the computing device 300 illustrated in FIG. 3, or an audio codec of the apparatus 500 illustrated in FIG. 5, and described below.

At block 402, the method 400 begins. At block 404, the method 400 receives an operating parameter associated with a fan that is activated within a computing device, wherein the operating parameter is received from a controller via a system management bus of the computing device. In an example, the operating parameter may include an RPM level of the fan, a current power consumption of the fan, a performance mode of the fan, and the like.

In an example, a table that correlates the operating parameter to a decibel level may be stored. The table may allow the codec to determine a decibel level of the sound signal generated by the fan based on the operating parameter or multiple operating parameters. In addition, a model number of the fan that is installed in the computing device may be received. A table may be created for the model number of the fan. Thus, if the computing device has multiple fans, a table that correlates the operating parameter to a decibel level for each model number of fans installed in the computing device may be created and stored in the memory of the computing device.

In an example, the table may allow the codec to determine a predetermined harmonic of the fan based on the operating parameter and the model number of the fan. The predetermined harmonic may be a wave form of the sound signal generated by the fan. The noise cancellation signal may be based on the predetermined harmonic of the fan that is determined.

At block 406, the method 400 generates a noise cancellation signal based on the operating parameter. As noted above, the predetermined harmonic or wave form of the sound signal generated by the fan may be determined based on the operating parameter and the model number of the fan using a table that is stored.

The noise cancellation signal may be an inverse wave form of the wave form associated with the predetermined harmonic. Thus, the noise cancellation signal, when combined with the wave form of the sound signal generated by the fan, may reduce the amplitude or decibel level of the sound signal generated by the fan.

At block 408, the method 400 transmits the noise cancellation signal to a speaker to be outputted by the speaker and cancel noise generated by the fan. The speaker may be located near the fan. The noise cancellation signal may be outputted by the speaker to be combined with the sound signal generated by the fan. The combination of the noise cancellation signal with the sound signal generated by the fan may help to reduce or cancel the sound signal generated by the fan. At block 410, the method 400 ends.

FIG. 5 illustrates an example of an apparatus 500. In an example, the apparatus 500 may be the apparatus 100, 200, or 300. In an example, the apparatus 500 may include a processor 502 and a non-transitory computer readable storage medium 504. The non-transitory computer readable storage medium 504 may include instructions 506 and 508 that, when executed by the processor 502, cause the processor 502 to perform various functions.

In an example, the instructions 506 may include detecting instructions. For example, the instructions 506 may detect that an internal temperature of a computing device exceeds a temperature threshold. For example, a temperature sensor may measure the internal temperature of the computing device. The temperature threshold may be set to a desired temperature by a user based on an acceptable noise level or decibel level for noise generated by a noise generating component within the computing device.

The instructions 508 may include activating instructions. For example, the instructions 508 may activate a noise cancellation codec and a fan in response to the internal temperature exceeding the temperature threshold, wherein the noise cancellation codec is to generate a noise cancellation signal based on an operating parameter received over a system management bus of the computing device when the fan is activated. The noise cancellation codec may be deactivated when the internal temperature falls back below the temperature threshold.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A computing device, comprising:
a system management bus;
a controller communicatively coupled to the system management bus;
a noise generating component communicatively coupled to the controller, wherein operating parameters of the noise generating component are provided to the controller;
a noise cancellation codec communicatively coupled to the system management bus, wherein the noise cancellation codec is to receive the operating parameters of the noise generating component from the controller via the system management bus and to generate a noise cancellation signal based on the operating parameters; and
a speaker communicatively coupled to the noise cancellation codec to output the noise cancellation signal to cancel noise generated by the noise generating component.

2. The computing device of claim 1, wherein the controller comprises a super input/output controller or an embedded controller.

3. The computing device of claim 1, wherein the noise generating component comprises an internal fan.

4. The computing device of claim 1, wherein the noise generating component comprises a graphical processing unit (GPU) with a dedicated fan.

5. The computing device of claim 1, wherein the operating parameters comprise at least one of: a fan speed, a power level, or a performance mode.

6. The computing device of claim 1, further comprising:
a non-transitory computer readable medium to store product information associated with the noise generating component.

7. The computing device of claim 6, wherein the product information comprises at least one of: a model number of the noise generating component or a serial number of the noise generating component.

8. The computing device of claim 6, wherein the noise cancellation signal is based on the operating parameters and the product information associated with the noise generating component.

9. The computing device of claim 1, further comprising:
a temperature sensor to measure an internal temperature of the computing device, wherein the controller is to activate the noise generating component and the noise cancellation codec when the internal temperature exceeds a temperature threshold.

10. A method, comprising:
receiving, by a processor, an operating parameter associated with a fan that is activated within a computing device, wherein the operating parameter is received from a controller via a system management bus of the computing device;
generating, by the processor, a noise cancellation signal based on the operating parameter; and
transmitting, by the processor, the noise cancellation signal to a speaker to be outputted by the speaker to cancel noise generated by the fan.

11. The method of claim 10, further comprising:
receiving, by the processor, a model number of the fan that is installed in the computing device; and
storing, by the processor, a table that correlates the operating parameter to a decibel level.

12. The method of claim 11, wherein the operating parameter comprises a current rotations per minute (RPM) of the fan.

13. The method of claim 12, wherein the generating comprises:
determining, by the processor, the decibel level that correlates to the current RPM based on the table for the model number of the fan that is installed to generate the noise cancellation signal.

14. The method of claim 10, wherein the generating comprises:
determining, by the processor, a predetermined harmonic of the fan based on the operating parameter and a model number of the fan; and
generating, by the processor, the noise cancellation signal based on the predetermined harmonic that is determined.

15. The method of claim 10, wherein the processor comprises a noise cancellation codec configured to communicate with the system management bus.

16. A non-transitory computer readable storage medium encoded with instructions which, when executed, cause a processor of a computing device to:
detect that an internal temperature of a computing device exceeds a temperature threshold; and
activate a noise cancellation codec and a fan in response to the internal temperature exceeding the temperature threshold, wherein the noise cancellation codec is to generate a noise cancellation signal based on an operating parameter received over a system management bus of the computing device when the fan is activated.

17. The non-transitory computer readable storage medium of claim 16, further comprising instructions executed by the processor to:
activate a speaker to output the noise cancellation signal to cancel noise generated by the fan.

18. The non-transitory computer readable storage medium of claim 17, wherein the operating parameter comprises at least one of: a fan speed, a power level, or a performance mode.

19. The non-transitory computer readable storage medium of claim 17, wherein the noise cancellation codec is to generate the noise cancellation signal based on the operating parameter and a plurality of different tables for different fans that correlate the operating parameter to a decibel level.

20. The non-transitory computer readable storage medium of claim 17, wherein the operating parameter is received over the system management bus from a controller communicatively coupled to the fan in response to a request sent over the system management bus from the noise cancellation codec when the noise cancellation codec is activated.
